(19) United States
(12) Patent Application Publication
(10) Pub. No.: US 2025/0284028 A1
(43) Pub. Date: Sep. 11, 2025

(54) METHOD FOR CALCULATING BEDLOAD SEDIMENT TRANSPORT RATE BY CORRECTING FRICTION COEFFICIENT IN BED SEDIMENT MOVEMENT

(71) Applicant: China Institute of Water Resources and Hydropower Research, Beijing (CN)

(72) Inventors: Lei ZHANG, Beijing (CN); Wen LU, Beijing (CN); Jianzhao GUAN, Beijing (CN); Zhidan HU, Beijing (CN); Jun FENG, Beijing (CN); Donghui SHEN, Beijing (CN); Yu LIU, Beijing (CN); Hai HUANG, Beijing (CN); Dayu WANG, Beijing (CN); Linqi LI, Beijing (CN); Jiaqi LIN, Beijing (CN); Hanmo CHEN, Beijing (CN); Yousheng WANG, Beijing (CN); Bing LIU, Beijing (CN); Lin DING, Beijing (CN); Yongfu LI, Beijing (CN)

(21) Appl. No.: 19/000,686

(22) Filed: Dec. 23, 2024

(30) Foreign Application Priority Data
Mar. 11, 2024 (CN) 202410273246.X

(51) Int. Cl. G01V 20/00; G01N 11/00

(52) U.S. Cl. CPC G01V 20/00; G01N 2011/006

(57) ABSTRACT

A method for calculating the bedload sediment transport rate by correcting the friction coefficient in the bed sediment movement is provided, including the following steps: S1, creating a calculation formula of a friction coefficient; S2, determining a calculation bedload sediment transport rate formula per unit width; S3, transforming the calculation formula of the bedload sediment transport rate per unit width into a dimensionless form; and S4, substituting the calculation formula of the bedload sediment transport rate per unit width obtained in the S2 into the S3 to obtain a bedload sediment transport rate formula with a corrected friction coefficient.

### CROSS-REFERENCE TO RELATED APPLICATIONS

This application claims priority to Chinese Patent Application No. 202410273246.X, filed on Mar. 11, 2024, the contents of which are hereby incorporated by reference.

### TECHNICAL FIELD

The disclosure belongs to the technical field of hydraulics and river dynamics, and is used for carrying out calculation research on bedload sediment transport rate, and in particular to a method for calculating the bedload sediment transport rate by correcting the friction coefficient in bed sediment movement.

### BACKGROUND

In natural river systems, sediment transport is primarily classified into two forms: suspended load and bedload. Bedload, as a crucial mechanism of sediment movement in rivers, is a complex process involving various physical interactions. It has consistently been a key area of focus in the field of riverine studies to precisely measure bedload sediment transport rates.

The patent CN 111832833 A discloses a calculation method of bedload sediment transport rates based on stochastic statistical theory, which reveals the influence of particle rolling and particle jumping on bedload transport and the proportion from the mechanism level, and simplifies the actual operation workload, including the following steps: firstly, the basic probability is calculated under different water and sediment conditions; secondly, the rolling parameters and rolling sediment transport rate under different water and sediment conditions are calculated based on the basic probability; thirdly, the jump parameters and jump sediment transport rate under different water and sediment conditions are calculated based on the basic probability; fourthly, according to the formula and different weighting coefficients, the bedload sediment transport rate is obtained.

The patent CN 113737710 A discloses an estimation method of bedload sediment transport rates in natural rivers, which includes the following steps: 1) obtaining boundary conditions: measuring the topography and flow field distribution of river sections by using an acoustic Doppler velocity profiler, and sampling to obtain the particle size gradation of sediment and the variation along the river width; 2) dividing sub-sections: dividing the whole river section into a plurality of sub-sections along the river width direction; 3) calculating the riverbed resistance coefficient of each sub-section: determining the riverbed resistance coefficient of each sub-section according to the measurement result of the acoustic Doppler flow velocity profiler; 4) calculating the average flow velocity of each sub-section; 5) calculating the height and movement speed of sand waves of each sub-section: determining the median particle size of bedload sediment according to the water depth, flow velocity and sediment particle size grading of each sub-section, and calculating the wave height and movement speed of sand waves of each sub-section; 6) calculating the bedload sediment transport rate of the whole section: determining the bedload sediment transport rate of each sub-section according to the wave height and movement speed of sand waves, and then obtaining the bedload sediment transport rate of the whole section, that is, the bedload sediment transport rates of natural rivers.

Zhou Shuang et al.'s paper “Study on Bedload Sediment Transport Rates based on Particle Saltation” published in Journal of Basic Science And Engineering, No. 8, 2021, discloses that the process of saltation particles impacting bed particles is observed by using high-speed camera technology, and the velocity recovery coefficient is determined by solving the collision model between saltation particles and bed particles, and the longitudinal velocity recovery coefficient is mainly determined by the angle of the impact surface. The vertical velocity recovery coefficient is mainly determined by the incident angle. By solving the equation of saltation motion, the formulas of average saltation height and saltation velocity considering the impact of particle collision are established. Based on the relationship between average particle concentration and effective flow intensity, the formula of uniform bedload sediment transport rate is derived.

In order to determine the bedload sediment transport rate, researchers have conducted extensive theoretical and empirical studies from various perspectives, and put forward many theoretical or empirical formulas, one of which is Bagnold's formula. Bagnold's approach is grounded in the belief that sediment transport is governed by fundamental physical principles. Drawing from the concept of stream power, he formulated expressions for both bedload and suspended load sediment transport rates. In Bagnold's bedload transport formula, one of the parameters to be determined is the friction coefficient μ, which is set as a constant according to the experience, usually at 0.63. However, the friction coefficient is not immutable; it varies with the dynamic conditions of water and sediment movement. The challenge of accounting for the multifaceted influences on the friction coefficient remains an unresolved issue in the study of sediment transport.

### SUMMARY

In response to the aforementioned challenges, the present disclosure introduces a method for calculating the bedload sediment transport rate that involves adjusting the friction coefficient within the context of bed sediment movement. This method is designed to account for the diverse factors and conditions affecting water and sediment movement that influence the friction coefficient. By refining the calculation of the bedload sediment transport rate, this approach yields a more accurate and reasonable estimation of the bedload sediment transport rate.

The method of the disclosure is realized as follows: a method for calculating bedload sediment transport rate by correcting friction coefficients in bed sediment movement, including the following steps:
S1, creating a calculation formula of a friction coefficient:
S11, determining a static friction coefficient, a recovery coefficient and a sediment particle temperature;
S12, determining volume weights of sediment particles and water flow, with the volume weight of the sediment particles being 2.65 g/cm³ and the volume weight of the water flow being 1.0 g/cm³, determining a particle size D and a settling velocity ω of the sediment particles, and determining a ratio m of an average height of bedload movement to the particle size of the sediment particles, and a calculation [symbol] method of is, where are a friction velocity and a critical [symbol] friction U_{*} and U_{*,c} velocity respectively;

$$m = 7.3 {( \frac{{U}_{*}}{{U}_{* , c}} )}^{0.6}$$

S2, determining a calculation bedload sediment transport rate formula per unit width;
S3, transforming the calculation formula of the bedload sediment transport rate per unit width into a dimensionless form; and
S4, substituting the calculation formula of the bedload sediment transport rate per unit width obtained in the S2 into the S3 to obtain a bedload sediment transport rate formula with a corrected friction coefficient;
where a method for calculating the friction coefficient in the S1 includes following steps:

$$μ = {μ}_{0} \{ erf ( \frac{{g}_{0}}{\sqrt{2 {T}_{t}} \overline{{μ}_{0}}} ) - \frac{5 k}{192} \frac{\sqrt{3 π}}{2} {R}_{t} [ \frac{4}{\overline{{μ}_{0}}} erfc ( \frac{{g}_{0}}{\sqrt{2 {T}_{t}} \overline{{μ}_{0}}} ) + \frac{8}{\sqrt{π} {g}_{0}} {( 2 {T}_{t} )}^{\frac{1}{2}} ( 1 - exp ( - \frac{{g}_{0}^{2}}{2 {T}_{t} {\overline{{μ}_{0}}}^{2}} ) ) ] \} \qquad ( 1 )$$

in the formula, μ₀ is the static friction coefficient, with values ranging from 0.4 to 0.6, Rₜ=D(du/dy)/\sqrt{3Tₜ}, u is a velocity, y is a vertical coordinate, t is time, Tₜ is the sediment particle temperature, [symbol] , e and ^{b}0 are vertical and tangential restitution coefficients, being [symbol] 0.9 and 0.8 respectively, and g₀ is an average velocity of contact points between the sediment particles and a bed surface, and k is a correction coefficient of suspended sediment particles to a viscosity coefficient, being calculated as follows:

$$\overline{{μ}_{0}} = \frac{7}{2} \frac{1 + e}{1 + {b}_{0}} {μ}_{0}$$

$$k = {\frac{2}{( 1 + e ) {f}_{0}} [ 1 + \frac{4}{5} ( 1 + e ) {f}_{0} v ]}^{2} + \frac{384 {v}^{2} {f}_{0} ( 1 + e )}{25 π} \qquad ( 2 )$$

in the formula, f₀ is a radial distribution function.

Further, substituting formula (1) into Bagnold's bedload transport formula, obtaining the bedload sediment transport rate per unit width g_{b}:

$${g}_{b} = \frac{{γ}_{s}}{{γ}_{s} - γ} \frac{{U}_{*} - {U}_{{*}_{c}}}{{U}_{*}} \frac{{τ}_{0}}{μ} [ 5.75 {U}_{*} log 30.2 ( \frac{mD}{{K}_{s}} ) - ω ]$$

in the formula, γₛ and γ are the volume weights of the sediment particles and the water flow respectively, and τ₀ is the shear stress of sediment particles, which is expressed as τ₀=ρU_{*}², ρ is the water flow density, Kₛ is the bed roughness, D is the sediment particle size, m is the ratio of the average height of bedload movement to the particle size of the sediment particles.

In the S3, the calculation formula of the bedload sediment transport rate per unit width is transformed into the dimensionless form by introducing shields number, and an expression is:

$$Θ = \frac{{τ}_{0}}{( {γ}_{s} - γ ) D} \qquad ( 4 )$$

an expression of dimensionless sediment transport rate Φ is:

$$Φ = \frac{{g}_{b}}{{γ}_{s}} \sqrt{\frac{γ}{( {γ}_{s} - γ ) {gD}^{3}}} ; \qquad ( 5 )$$

a bedload sediment transport rate formula after the friction coefficient is corrected in the S4 is as follows:

$$Φ = \frac{Θ ( \sqrt{Θ} - \sqrt{{Θ}_{c}} ) [ 5.75 log 30.2 ( \frac{mD}{{K}_{s}} ) - \frac{ω}{{U}_{*}} ]}{\begin{matrix}{μ}_{0} \{ erf ( \frac{{g}_{0}}{\sqrt{2 {T}_{t}} \overline{{μ}_{0}}} ) - \frac{5 k}{192} \frac{\sqrt{3 π}}{2} {R}_{t} [ \frac{4}{\overline{{μ}_{0}}} erfc ( \frac{{g}_{0}}{\sqrt{2 {T}_{t}} \overline{{μ}_{0}}} ) + \\ \frac{8}{\sqrt{π} {g}_{0}} {( 2 {T}_{t} )}^{1 / 2} ( 1 - exp ( - \frac{{g}_{0}^{2}}{2 {T}_{t} {\overline{{μ}_{0}}}^{2}} ) ) ] \}\end{matrix}} . \qquad ( 6 )$$

Further, a proportion of data points with the error of a calculated value of Bagnold's bedload sediment transport rate within a range of 0.5-2 times of a measured value after the friction coefficient is corrected is more than 60%.

The disclosure has the beneficial effects that the bedload sediment transport rate formula is the key constitutive relation in the mathematical model of water and sediment, and improving the calculation accuracy of bedload sediment transport rate will directly improve the calculation accuracy of the model, and the calculation accuracy of the model directly determines the accuracy of river erosion and deposition evolution calculation, thus affecting the rationality and effectiveness of river regulation engineering measures. The method of the disclosure considers the influence of various factors and conditions of water and sediment movement on the friction coefficient in the formula, and the accuracy of the formula for calculating the sediment transport rate of the Bagnold's bedload sediment transport rate corrected by the friction coefficient is greatly improved, which is better in agreement with the measured data. After the friction coefficient is corrected, the data points with the error of the calculated value of Bagnold's bedload sediment transport rate within the range of 0.5-2 times of the measured value are greatly increased, and the proportion is increased from 32.57% to 61.36%, with an increase of nearly 30%. Therefore, the calculation method of the disclosure may provide more reliable technical support for the decision-making of river regulation projects and water conservancy engineering construction.

In the following, the disclosure will be further explained with the attached drawings and specific embodiments.

### BRIEF DESCRIPTION OF THE DRAWINGS

FIG. 1 shows a comparison between the measured and the calculated bedload sediment transport rate after the friction coefficient is corrected.

FIG. 2 shows a comparison of the ratio of revised Bagnold's formula calculation value to measured value and the ratio of original Bagnold's formula calculation value to measured value.

### DETAILED DESCRIPTION OF THE EMBODIMENTS

The disclosure relates to a method for calculating bedload sediment transport rates by correcting friction coefficients in bed sediment movement, which includes the following steps:
S1, creating a calculation formula of a friction coefficient:
S11, determining a static friction coefficient, a recovery coefficient and a sediment particle temperature;
S12, determining volume weights of sediment particles and water flow, with the volume weight of the sediment particles being 2.65 g/cm³ and the volume weight of the water flow being 1.0 g/cm³, determining a particle size D and a settling velocity ω of the sediment particles, and determining a ratio m of an average height of bedload movement to the particle size of the sediment particles, and a calculation method of m is, where are a friction velocity and a critical friction vel [symbol] U_{*} and U_{*,c}

$$m = 7.3 {( \frac{{U}_{*}}{{U}_{* , c}} )}^{0.6}$$

S2, determining a calculation bedload sediment transport rate formula per unit width;
S3, transforming the calculation formula of the bedload sediment transport rate per unit width into a dimensionless form; and
S4, substituting the calculation formula of the bedload sediment transport rate per unit width obtained in the S2 into the S3 to obtain a bedload sediment transport rate formula with a corrected friction coefficient;
where a method for calculating the friction coefficient in the S1 includes following steps:

$$μ = {μ}_{0} \{ erf ( \frac{{g}_{0}}{\sqrt{2 {T}_{t}} \overline{{μ}_{0}}} ) - \frac{5 k}{192} \frac{\sqrt{3 π}}{2} {R}_{t} [ \frac{4}{\overline{{μ}_{0}}} erfc ( \frac{{g}_{0}}{\sqrt{2 {T}_{t}} \overline{{μ}_{0}}} ) + \frac{8}{\sqrt{π} {g}_{0}} {( 2 {T}_{t} )}^{\frac{1}{2}} ( 1 - exp ( - \frac{{g}_{0}^{2}}{2 {T}_{t} {\overline{{μ}_{0}}}^{2}} ) ) ] \} \qquad ( 1 )$$

$$μ = {μ}_{0} \{ erf ( \frac{{g}_{0}}{\sqrt{2 {T}_{t}} \overline{{μ}_{0}}} ) - \frac{5 k}{192} \frac{\sqrt{3 π}}{2} {R}_{t} [ \frac{4}{\overline{{μ}_{0}}} erfc ( \frac{{g}_{0}}{\sqrt{2 {T}_{t}} \overline{{μ}_{0}}} ) + \frac{8}{\sqrt{π} {g}_{0}} {( 2 {T}_{t} )}^{\frac{1}{2}} ( 1 - exp ( - \frac{{g}_{0}^{2}}{2 {T}_{t} {\overline{{μ}_{0}}}^{2}} ) ) ] \}$$

in the formula, μ₀ is the static friction coefficient, with values ranging from 0.4 to 0.6, [symbol]
   , u is a velocity, y is a vertical coordinate, t is time, Tₜ is the sediment particle temp [symbol] , e and ^{b}0 are vertical and tangential recovery coefficients, [symbol] respectively, and g₀ is an average velocity of contact points between the sediment particles and a bed surface, and k is a correction coefficient of suspended sed [symbol] g₀=u₀+(D/2)n×w viscosity coefficient, being calculated as follows:

Rₜ=D(du/dy)/\sqrt{3Tₜ}

$$\overline{{μ}_{0}} = \frac{7}{2} \frac{1 + e}{1 + {b}_{0}} {μ}_{0} ,$$

In the formula, f₀ is a radial distribution function,

$${f}_{0} = {( 1 - \frac{v}{{v}_{m}} )}^{- 5 {v}_{m} / 2} ,$$

for sediment [symbol] particles, [symbol] vₘ=0.64; v is a concentration of the sediment particles, and e is a vertical recovery coefficient.

$$k = {\frac{2}{( 1 + e ) {f}_{0}} [ 1 + \frac{4}{5} ( 1 + e ) {f}_{0} v ]}^{2} + \frac{384 {v}^{2} {f}_{0} ( 1 + e )}{25 π} \qquad ( 2 )$$

substituting formula (1) into Bagnold's bedload transport formula, obtaining the bedload sediment transport rate per unit width g_{b}:

$${g}_{b} = \frac{{γ}_{s}}{{γ}_{s} - γ} \frac{{U}_{*} - {U}_{* c}}{{U}_{*}} \frac{{τ}_{0}}{μ} [ 5.75 {U}_{*} log 30.2 ( \frac{m D}{{K}_{s}} ) - ω ] \qquad ( 3 )$$

in the formula, γₛ and γ are the volume weights of the sediment particles and the water flow respectively, τ₀ is a shear force of the sediment particles, with an expression of τ₀=ρU_{*}², ρ is a water flow density, Kₛ is a bed roughness, D is the particle size of the sediment particles, m is the ratio of the average height of the bedload movement to the particle size of the sediment particles, and ω is the settling velocity of the sediment particles;
in the S3, the calculation formula of the bedload sediment transport rate per unit width is transformed into the dimensionless form by introducing shields number, and an expression is:

$$Θ = \frac{{τ}_{0}}{( {γ}_{s} - γ ) D} \qquad ( 4 )$$

an expression of dimensionless sediment transport rate Φ is:

$$Φ = \frac{{g}_{b}}{{γ}_{s}} \sqrt{\frac{γ}{( {γ}_{s} - γ ) g {D}^{3}}} ; \qquad ( 5 )$$

a bedload sediment transport rate formula after the friction coefficient is corrected in the S4 is as follows:

$$Φ = \frac{Θ ( \sqrt{Θ} - \sqrt{{Θ}_{ζ}} ) [ 5.75 log 30.2 ( \frac{m D}{{K}_{s}} ) - \frac{ω}{{U}_{*}} ]}{{μ}_{0} \{ erf ( \frac{{g}_{0}}{\sqrt{2 {T}_{t}} \overline{{μ}_{0}}} ) - \frac{5 k}{192} \frac{\sqrt{3 π}}{2} {R}_{t} [ \frac{4}{\overline{{μ}_{0}}} erfc ( \frac{{g}_{0}}{\sqrt{2 {T}_{t}} \overline{{μ}_{0}}} ) + \frac{8}{\sqrt{π} {g}_{0}} {( 2 {T}_{t} )}^{1 / 2} ( 1 - exp ( - \frac{{g}_{0}^{2}}{2 {T}_{t} \overline{{μ}_{0}^{2}}} ) ) ] \}} . \qquad ( 6 )$$

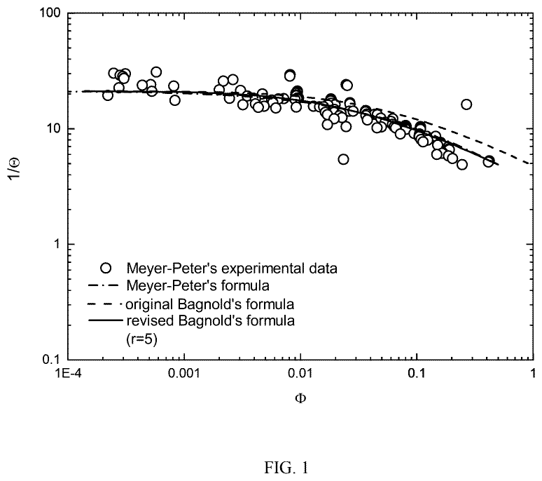

The bedload sediment transport rate calculated based on the above steps is compared with the collected classical Meyer-Peter (1948) measured data and Meyer-Peter formula (see Table 1), and the results are shown in FIG. 1. From the FIG. 1, it can be seen that the results calculated by the corrected bedload sediment transport rate formula may be better consistent with the measured values. In addition, the results calculated by the corrected bedload sediment transport rate formula are in good agreement with the results calculated by the classical Meyer-Peter empirical formula.

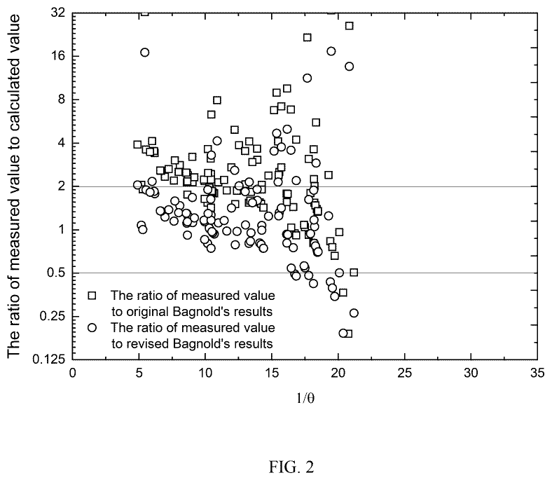

On this basis, the variation law of the ratio of measured value to calculated value with shields number is further counted, and as can be seen from FIG. 2, the data points with the error of the corrected Bagnold's calculated value within the range of 0.5-2 times the measured value are greatly increased, and the proportion increases from 32.57% to 61.36%, with an increase of nearly 30%.

Based on the analysis of the above two aspects, it can be seen that the accuracy of the calculation formula of in Bagnold's bedload sediment transport rate considering the correction of friction coefficient has been greatly improved, which is in better agreement with the measured data, and it also shows that the disclosure has good and practical value.

TABLE 1
Comparison of water and sediment parameters and calculation results of different
bedload sediment transport rates in Meyer-Peter bedload transport experiment

| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
|---|---|---|---|---|---|---|---|---|---|---|---|---|---|---|---|---|---|
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |

[symbol]

indicates data missing or illegible when filed

Finally, it should be noted that the above is only used to illustrate the technical scheme of the present disclosure, but not to limit it. Although the present disclosure has been described in detail with reference to the preferred embodiments, it should be understood by those skilled in the art that the technical scheme of the present disclosure may be modified or replaced by equivalents without departing from the spirit and scope of the technical scheme of the present disclosure.

What is claimed is:

1. A method for calculating a bedload sediment transport rate by correcting a friction coefficient in bed sediment movement, wherein the method comprises following steps:
S1, creating a calculation formula of a friction coefficient:
S11, determining a static friction coefficient, a recovery coefficient and a sediment particle temperature; and
S12, determining volume weights of sediment particles and water flow, with the volume weight of the sediment particles being 2.65 g/cm³ and the volume weight of the water flow being 1.0 g/cm³, determining a particle size D and a settling velocity ω of the sediment particles, and determining a ratio m of an average height of bedload movement to the particle size of the sediment particles, and a calculation method of m is, wherein are a friction velocity and a critical fri [symbol] U_{*} and U_{*,c}
$$m = 7.3 {( \frac{U \text{?}}{U \text{?}} )}^{0.6} ively ;$$
$$\text{?} \text{indicates text missing or illegible when filed}$$
S2, determining a calculation bedload sediment transport rate formula per unit width;
S3, transforming a calculation formula of the bedload sediment transport rate per unit width into a dimensionless form; and
S4, substituting the calculation formula of the bedload sediment transport rate per unit width obtained in step S2 into step S3 to obtain a bedload sediment transport rate formula with a corrected friction coefficient;
wherein a method for calculating the friction coefficient in the step S1 comprises:
$$μ = {μ}_{0} \{ erf ( \frac{{g}_{0}}{\sqrt{2 {T}_{t}} \overline{{μ}_{0}}} ) - \frac{5 k}{192} \frac{\sqrt{3 π}}{2} {R}_{t} [ \frac{4}{\overline{{μ}_{0}}} erfc ( \frac{{g}_{0}}{\sqrt{2 {T}_{t}} \overline{{μ}_{0}}} ) + \frac{8}{\sqrt{π} {g}_{0}} {( 2 {T}_{t} )}^{\frac{1}{2}} ( 1 - exp ( - \frac{{g}_{0}^{2}}{2 {T}_{t} \overline{{μ}_{0}^{2}}} ) ) ] \} \qquad ( 1 )$$
wherein μ₀ is the static friction coefficient, with values ranging from 0.4 to 0.6, D(du/dy)/\sqrt{3Tₜ}, u is a velocity, y is a vertical coordinate, t is time, Tₜ is the sediment particle [symbol] e and b₀ are vertical and tangential recovery coefficients, being 0.9 and 0.8 respectively, and g₀ is an average velocity of contact points between the sediment particles and a
$$\overline{{μ}_{0}} = \frac{7}{2} \frac{1 + e}{1 + {b}_{0}} {μ}_{0} ,$$
$$k = {\frac{2}{( 1 + e ) {f}_{0}} [ 1 + \frac{4}{5} ( 1 + e ) {f}_{0} v ]}^{2} + \frac{384 {v}^{2} {f}_{0} ( 1 + e )}{25 π} \qquad ( 2 )$$
bed surface, and k is a correction coefficient of suspended sediment particles to a viscosity coefficient, adopting a following calculation method:
wherein f₀ is a radial distribution function, [symbol] , vₘ=0.64; v is a concentration of the sediment particles, and e is a vertical recovery coefficient;
substituting formula (1) into Bagnold's bedload transport formula, obtaining the bedload sediment transport rate g_{b} per unit width:
$${g}_{b} = \frac{{γ}_{s}}{{γ}_{s} - γ} \frac{{U}_{*} - {U}_{* c}}{{U}_{*}} \frac{{τ}_{0}}{μ} [ 5.75 {U}_{*} log 30.2 ( \frac{m D}{{K}_{s}} ) - ω ] \qquad ( 3 )$$
wherein γₛ and γ are the volume weights of the sediment particles and the water flow respectively, τ₀ is a shear force of the sediment particles, with an expression of τ₀=ρU_{*}², ρ is a water flow density, Kₛ is a bed roughness, D is the particle size of the sediment particles, m is the ratio of the average height of the bedload movement to the particle size of the sediment particles, and ω is the settling velocity of the sediment particles;
in the step S3, the calculation formula of the bedload sediment transport rate per unit width is transformed into the dimensionless form by introducing shields number, and an expression is:
$$Θ = \frac{{τ}_{0}}{( {γ}_{s} - γ ) D} \qquad ( 4 )$$
an expression of a dimensionless sediment transport rate Φ is:
$$Φ = \frac{{g}_{b}}{{γ}_{s}} \sqrt{\frac{γ}{( {γ}_{s} - γ ) g {D}^{3}}} ; \qquad ( 5 )$$
a bedload sediment transport rate formula after the friction coefficient corrected in step S4 is:
$$Φ = \frac{Θ ( \sqrt{Θ} - \sqrt{{Θ}_{ζ}} ) [ 5.75 log 30.2 ( \frac{m D}{{K}_{s}} ) - \frac{ω}{{U}_{*}} ]}{{μ}_{0} \{ erf ( \frac{{g}_{0}}{\sqrt{2 {T}_{t}} \overline{{μ}_{0}}} ) - \frac{5 k}{192} \frac{\sqrt{3 π}}{2} {R}_{t} [ \frac{4}{\overline{{μ}_{0}}} erfc ( \frac{{g}_{0}}{\sqrt{2 {T}_{t}} \overline{{μ}_{0}}} ) + \frac{8}{\sqrt{π} {g}_{0}} {( 2 {T}_{t} )}^{1 / 2} ( 1 - exp ( - \frac{{g}_{0}^{2}}{2 {T}_{t} \overline{{μ}_{0}^{2}}} ) ) ] \}} . \qquad ( 6 )$$

2. The method for calculating the bedload sediment transport rate by correcting the friction coefficient in the bed sediment movement according to claim 1, wherein a proportion of data points with the error of a calculated value of Bagnold's bedload sediment transport rate within a range of 0.5-2 times of a measured value after the friction coefficient is corrected is more than 60%.
